(19) United States
(12) Patent Application Publication
(10) Pub. No.: US 2004/0133466 A1
(43) Pub. Date: Jul. 8, 2004

(54) Integrated distribution network for media storage units and changeable advertising using a media vending machine

(76) Inventors: Corey Anthony Redmond, Los Angeles, CA (US); David Eugene Treston, West Hollywood, CA (US)

Correspondence Address: GREENBERG TRAURIG LLP, 2450 COLORADO AVENUE, SUITE 400E, SANTA MONICA, CA, 90404, US

(21) Appl. No.: 10/336,326

(22) Filed: Jan. 3, 2003

(51) Int. Cl. G06F 17/60

(52) U.S. Cl. 705/14

(57) ABSTRACT

A system collects and analyzes data to determine a media storage unit to be distributed through a media distribution network for positioning in a media vending machine. A media purveyor receives popularity data, sales data for the media storage unit within a defined geographical region, demographic data, and inventory data to help the media purveyor in determining which media storage units should be positioned within a media vending machine. The media purveyor provides data to advertisers to assist the advertisers in composing an offer for advertising space on the media vending machine. After receiving the offers from the advertisers, the media purveyor can determine which advertisement to place on the media vending machine.

### FIELD OF THE INVENTION

This invention relates generally to a method and system for distributing data. More particularly, the present invention relates to distributing data stored on a medium readable by an audio apparatus, a visual apparatus, or a computer apparatus.

### BACKGROUND OF THE INVENTION

A multitude of distribution related industries presently face the challenge of expanding into more successful ventures. In particular, the vending industry, entertainment industry, and advertising industry are all successful but cannot reach their full potential because of limited business models.

The vending machine industry is a loose confederation of manufacturers, distributors and vendors on national, regional and independent levels. Presently, vendors provide access to products such as drinks, food, and cigarettes. Generally, most vending companies operate vending machines by contracting independently with entities such as factories, office complexes, universities, etc. According to the Vending Times Census of the Industry, 2001, the vending industry had total sales of nearly $39 billion in 1998.

Although the vending industry has proven itself to be quite successful, its financial success has not been well publicized. This lack of publicity possibly stems from the limited kind of products presently sold in vending machines (e.g., candy, sweets, coffee, etc.). Therefore, the vending industry is having difficulty attracting new clientele and expanding the business to its fullest potential.

Similarly, the music industry is also a very successful industry that has “peaked”. Although the music industry is a multi-billion dollar industry, major changes have recently taken place in consumer spending habits because of new digital music options such as “Napster” and “Morpheus”. For instance, although sales for full length CDs continue to dominate the music sales market, CD singles dropped by 50% from last year according to the Recording Industry Association of America, Market Report on US Recorded Music Shipments, 2000. The music industry is not presently accommodating the consumer's need to have the latest hit single at the press of a keystroke. The music industry's solution of expecting the consumer to travel to a record store to purchase a single is simply unrealistic when the consumer can download a single in the confines of his or her own home.

Further, while the overall CD market is growing, the vast majority of artists are not profitable. Each year, the RIAA estimates that of the 27,000 new releases put out on the market, the major labels release about 7,000 new CD titles. Most of these new CD titles never sell enough to recover promotion and distribution costs, let alone to be profitable. Of the best sellers, less than 10% of these releases are actually profitable, and it is these recordings that finance the rest of the releases.

Another distribution related industry is the advertising industry, which profits more when it can be shown that the product advertised was heavily sold. A good deal of advertising occurs in the form of billboards. Presently, the advertising industry is a $236 billion dollar industry. The advertising industry is facing the challenge of proving to its clients that an expensive billboard actually has a correlation with increased sales. Billboards are usually placed at a very large height above street level. Many passerbys don't even notice the billboards as they are driving because the billboards are simply too high off the ground and are off to the side of the street. Advertisers need much less expensive forms of advertising that have a more direct impact at the point of sale.

Further, the advertising industry is facing a new challenge from technologies such as Digital Video Recorders (DVR's). TiVo, which is presently the most popular DVR, allows users to record television programs without the advertisements. The advertising industry is therefore having to determine a way of accessing potential consumers through other venues. A need exists for the vending, music, and advertising industries to expand their markets.

### SUMMARY OF THE INVENTION

The present invention solves these and other problems by providing a method for utilizing a media vending machine in a data communication network. First, popularity data outlining popularity of a media storage unit is received. Then sales data for the media storage unit within a defined geographical area is received. Next, demographic data from a point of sale location is received. Inventory data for the media storage unit is then received. Data is subsequently provided to advertisers to assist the advertisers in composing an offer for advertising space on the media vending machine. Offers are then received from the advertisers for advertising space on the media vending machine. The media storage units to be positioned in the media vending machine are determined based upon an analysis of the popularity data, the sales data, the demographic data, and the inventory data. Based on the advertising offers, an advertisement is determined to be placed on the media vending machine.

Another aspect of the present invention is a system which collects and analyzes data to determine a media storage unit to be distributed through a media distribution network for positioning in a media vending machine. A media purveyor receives popularity data regarding a media storage unit from a media storage unit producer. The media purveyor receives sales data regarding the media storage unit within a geographic area from a data collection entity. Further, the media purveyor receives demographic data from a point of sale location. In addition, the media purveyor provides data to advertisers to allow the advertisers to compose an offer for advertising space on the media vending machine. The media purveyor also receives offers from advertisers for advertising space on the media vending machine. The media purveyor performs an analysis to determine what media storage units to obtain from the media storage unit producer. Finally, the media purveyor also obtains the media storage units from the media storage unit producer based upon the analysis.

Another aspect of the present invention is a media vending machine. The media vending machine has a housing having located therein a plurality of media storage units. A plurality of actuators are operably connected to the housing such that a user can press one of the plurality of actuators in order to make a selection from one of the plurality of media storage units. A plurality of actuator images are operably associated with respective ones of the plurality of actuators. The plurality of actuator images correspond to displays operably connected to corresponding media storage units. Further, the plurality of actuator images are arranged according to popularity of the media storage unit. Accordingly, popularity is determined by demographic data in the geographic location in which the media vending machine is positioned. Further, an actuator image is operably connected to each of the plurality of actuators corresponding to a display operably connected to each of the media storage units. In addition, a payment receiver is operably connected to the housing. After the user has provided payment to the payment receiver and has made a selection from one of the plurality of actuators, a vending tray receives at least one of the plurality of media storage units. Further, a controller is operably connected to the plurality of actuators. Upon the user's selection of one of the plurality of actuators, the controller selects the media storage unit corresponding to the selected actuator and dispenses the corresponding media storage unit in the vending tray.

Another aspect of the present invention is a method for displaying advertisements on a media vending machine. Advertisers are provided with data to assist the advertisers in making an offer for advertising space on the media vending machine. A first plurality of offers is received from advertisers for advertising space on the media vending machine. A first offer for advertising space is then selected for the media vending machine. A first advertisement is attached corresponding to the selected first offer to the media vending machine. After a period of time has elapsed, a second plurality of offers is then received from advertisers for advertising space on the media vending machine. A second offer for advertising space on the media vending machine is then selected. Next, the first advertisement is removed from the media vending machine. A second advertisement corresponding to the selected second offer is then attached to the media vending machine.

Another aspect of the present invention is a method of positioning media storage units within a media vending machine. Media storage units are received for positioning within a media vending machine. Next, the media storage units are positioned within the media vending machine. Actuator images are then arranged according to popularity of the media storage unit. Popularity is determined by demographic data in the geographic location in which the media vending machine is positioned. The plurality of actuators are operably connected to the housing such that a user can operate one of the plurality of actuators in order to make a selection from one of the plurality of media storage units. The unused media storage units are sent to a media purveyor.

Another aspect of the present invention is a media vending machine. The media vending machine has a housing having therein locations for receiving a plurality of media storage units. The media vending machine also has an actuator system connected to the housing so that a user can operate the actuator system in order to make a selection from one of the plurality of media storage units. The media vending machine also has an actuator image operably connected to each of the plurality of actuators corresponding to a display operably connected to a corresponding media storage unit. The media vending machine also has a payment receiver operably connected to the housing. A vending tray receives at least one of the plurality of media storage units after the user has provided payment to the payment receiver and has made a selection from one of the plurality of actuators. A controller is operably connected to the plurality of actuators. The controller, upon the user's selection of one of the plurality of actuators, selects the media storage unit corresponding to the selected actuator and dispenses the corresponding media storage unit in the vending tray.

### BRIEF DESCRIPTION OF THE DRAWINGS

The various novel features of the invention are illustrated in the figures listed below and described in the detailed description that follows.

FIG. 1A illustrates one embodiment of the media vending machine.

FIG. 1B illustrates how a payment is made in the media vending machine.

FIG. 1C illustrates an embodiment of an actuator operably connected to the media vending machine.

FIG. 1D illustrates the placement of the media storage units on shelves housed within the media vending machine.

FIG. 1E illustrates an embodiment of the media vending machine in which the plurality of actuators are operably connected to a surface that protrudes from the housing of the media vending machine.

FIG. 1F illustrates an embodiment of the media vending machine in which selection buttons are operably connected to the housing.

FIG. 1G illustrates an embodiment of the media vending machine in which selection levers are operably connected to the media vending machine.

FIG. 1H illustrates an embodiment of the media vending machine in which a dial is used to make a selection of the media storage unit.

FIG. 1I illustrates an embodiment of the media vending machine in which a dial is used to make a selection of the media storage unit with a display screen.

FIGS. 2A-2I illustrate different arrangements for the plurality of actuators.

FIG. 3 illustrates a process for using the media vending machine.

FIG. 4 illustrates another embodiment of the media vending machine illustrated in FIG. 1.

FIG. 5 illustrates another embodiment of the media vending machine illustrated in FIG. 4.

FIG. 6 illustrates a block diagram of an integrated distribution network for media storage units and changeable advertising.

FIG. 7 illustrates a process for the media purveyor for coordinating data, distributing media storage units, and determining advertising between the entities described in FIG. 6.

FIG. 8 illustrates the integrated distribution network illustrated in FIG. 6 with the addition of a network that the media purveyor can use to send to and receive data from the point of sale location.

FIG. 9A illustrates a process in which the media purveyor can coordinate with vendors with respect to stocking and maintenance of the media vending machine.

FIG. 9B illustrates a process similar to that of FIG. 9A but where the media storage units have already been pre-ordered.

FIG. 10 illustrates a process in which the media purveyor works in conjunction with the vendors.

FIG. 11 illustrates a process in which the media purveyor works in coordination with media advertisers.

FIG. 12 illustrates a process for changeable advertising on the media vending machine.

### DETAILED DESCRIPTION OF THE PREFERRED EMBODIMENTS

In order to solve the associated problems of the music, vending, and advertising industries, one aspect of the present invention is a media vending machine 100. One of the reasons that the music industry depends so much on such a small percentage of new CD titles lies in the music industry's business model, which does not have an accurate way to determine customer taste in music. Presently, music retailing primarily exists in large retail music store chains. The music retailers pre-order CD's before the CD's are ever released and before customer taste has been measured. Many of the music charts base their rankings on how many CD's were ordered by the music retailers. As each customer purchases a CD from a retailer, the retailer usually electronically communicates the sales information to a research company, such as Soundscan, Inc., at the point of sale. The research company then compiles the actual sales of a particular CD purchased by consumers as opposed to sales of the CD purchased by a retailer. The research company can then report back to the retailers with statistics indicating how popular the CD is amongst consumers. The retailers can then use these statistics to determine if their initial pre-order of CD's was a good guess at how popular the CD would be. If the retailers overestimated the popularity of the CD, the retailers can return the CD's to the record labels. If the retailers underestimated the popularity of the CD, the retailers can order more CD's. The music industry needs a better way of determining what CD's will be profitable than having retail stores making a guess with a pre-order and hoping that the guess is correct.

With the use of the media vending machine 100, a business model (as will be later described) for a network can be used to help these three industries. The business model will allow the vending industry to expand the product it offers. It will also allow the music industry to better estimate and increase targeted sales. Finally, the business model will provide advertisers with a new forum for placing advertisements that is less expensive while having a more direct impact on consumers.

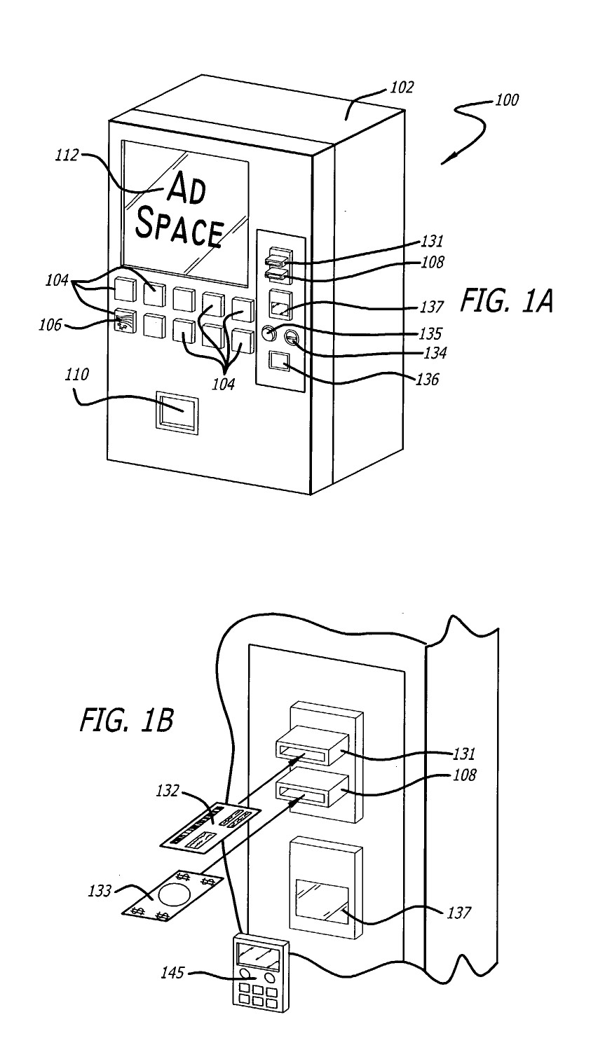

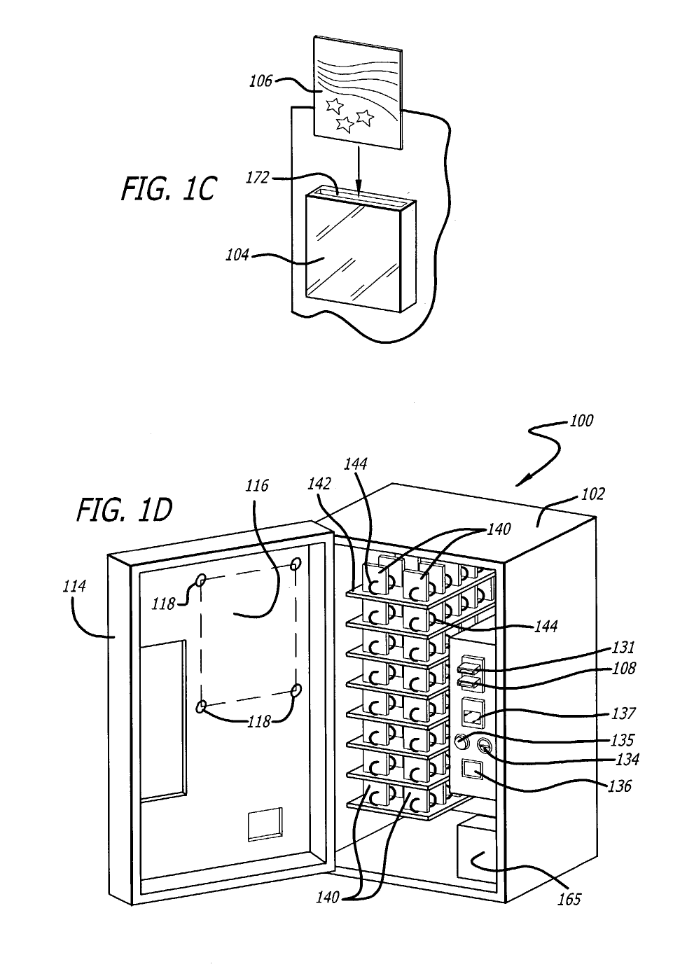

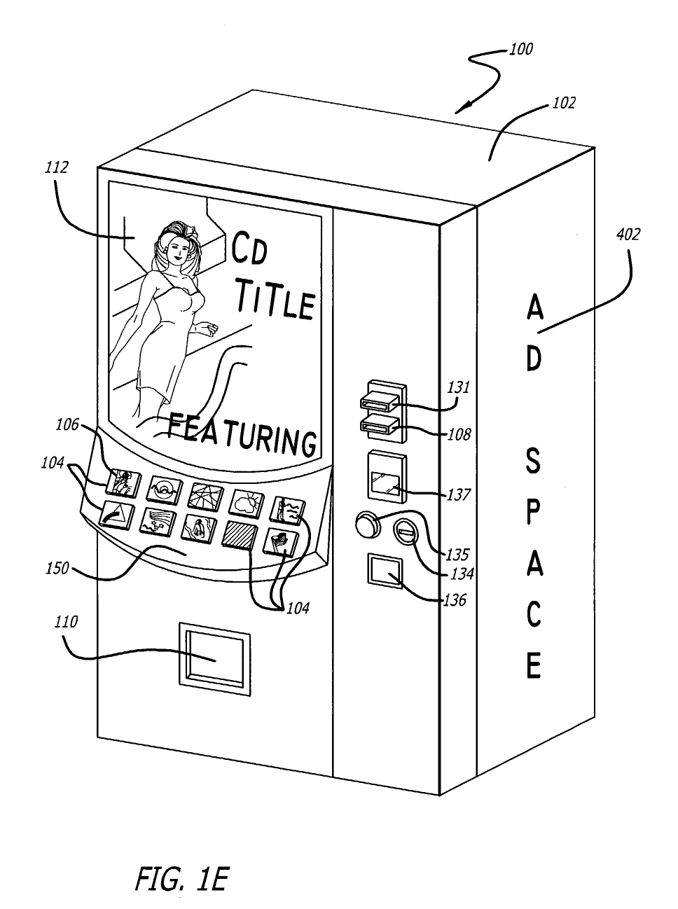

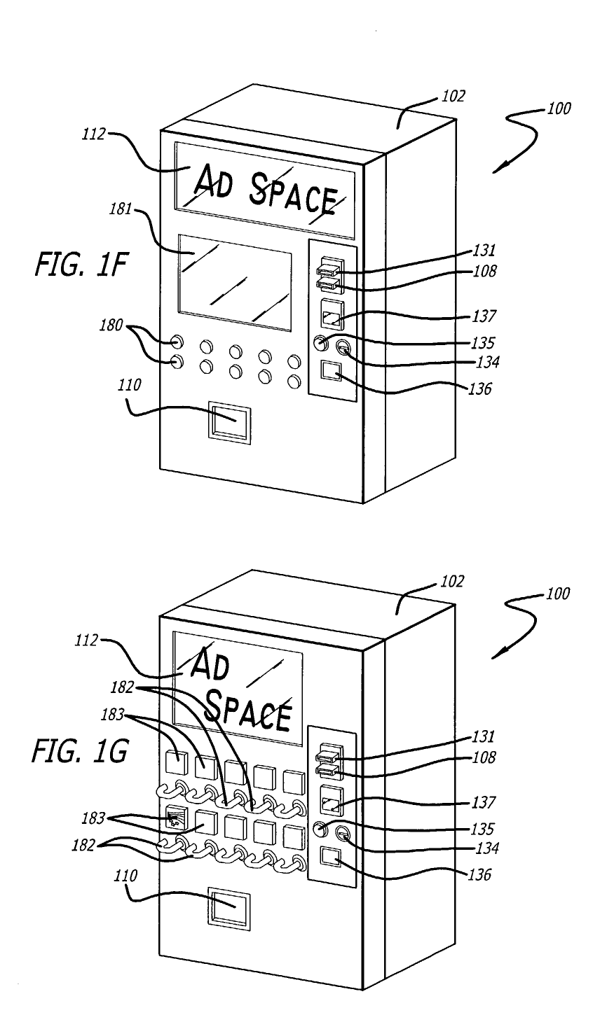

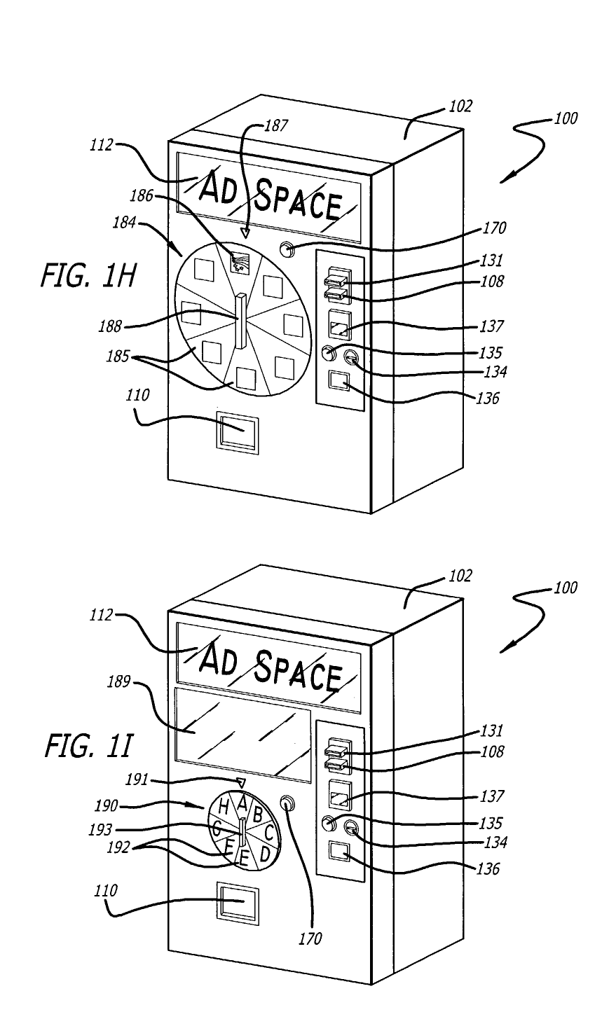

The media vending machine 100 delivers media storage units 140 (FIG. 1D) and targeted advertising to the consumer by tapping into the impulse-buy instinct of the consumer. A media storage unit 140 stores data which can be read by an electronic device. The media storage units that can be distributed through the media vending machine 100 include CD's, DVD's, video games, computer software, flash memories, VHS tapes, and any other media storage unit readable by future electronic devices.

In one embodiment, the media vending machine 100 distributes top ten selling CD's. The media vending machine 100 is advantageously placed in a location such as a grocery store, movie theatre, airport, park, etc. so that the user can conveniently access the media storage units. Alternatively, the media vending machine 100 can distribute the top five, top twenty, or any other numerical variation of top selling CD's. In another embodiment, the media vending machine 100 sells the top selling DVD's. In one embodiment, the media vending machines 100 sell a combination of top selling CD's and DVD's. In another embodiment, the media vending machine 100 can distribute different types of media storage units 140, such as CD's, DVD's, video games, etc. all in one media vending machine 100. For example, the media vending machine 100 can distribute a DVD of a movie, a CD for the soundtrack for the movie, and a video game for the movie all in one media vending machine 100. In other embodiments the media vending machine 100 distributes different media storage units 140 as outlined above or any combination thereof as is determined by the various factors enumerated herein.

FIG. 1A illustrates one embodiment of the media vending machine 100. The media vending machine 100 includes a housing 102 which stores the media storage units 140. The consumer can choose from one of a plurality of actuators 104 to make a selection of media storage units 140. The plurality of actuators 104 can be buttons, levers, or switches. The user can choose from the plurality of actuators 104 by viewing the actuator image 106. The actuator image 106 can be a photograph, a computer generated image displayed on printed paper, a drawing, a computer generated image displayed on a video display, a computer generated image displayed on a liquid crystal display, or plasma screen, or any other form of display known to those of ordinary skill in the art. The actuator image 106 will likely correspond to the image placed on the cover of the container for the media storage unit 140. However, the actuator image 106 can have a different image than from the cover of the associated media storage unit 140. For instance, the actuator image 106 may just convey the name of the artist without the associated artwork of a CD cover. Further, the term “correspond” shall not require identical language to be displayed on the actuator image 106 and the cover of the media storage unit 140. All that is needed to show correspondence is a relation between the actuator image 106 and the storage unit 140 cover. For instance, the name of the artist can appear in different fonts and sizing on the actuator image 106 and the cover of the media storage unit 140, yet a correspondence can exist. The actuator image 106 can include words, symbols, or numerics.

The plurality of actuators 104 can have a housing in which the actuator images 106 can be placed. Alternatively, the actuator images 106 can be adhered to the exterior of the plurality of actuators 104. The user can insert the payment mechanism into the payment receiver 108 in order to make a selection. When the user presses one of the plurality of actuators 104, the user makes a selection of the media storage unit housed within the housing 102 that is identified by the actuator image 106.

A controller 165 (FIG. 1D) which is operably connected to the plurality of actuators 140 selects the media storage unit 140 corresponding to the selected actuator 104. The mechanics of how the media vending machine 100 chooses a media storage unit 140 after the user's selection to be distributed to the user through a vending tray 110 are similar to that of a regular vending machine and are well known in the art. U.S. Pat. No. 6,253,955 (Bower), U.S. Pat. No. 6,241,119 (Stephenson), U.S. Pat. No. 6,170,285 (Huffman, et al.), U.S. Pat. No. 6,199,720 (Rudick, et al.), and U.S. Pat. No. 6,155,455 (Yajima, et al.) describe the mechanics of how a typical vending machine operates. (The entire contents of each of these patents are hereby incorporated by reference.) The mechanical components of the media vending machine 100 will determine the associated media storage unit 140 for the actuator 104 that the user presses. Further, the mechanical components will deliver a media storage unit 140 from a storage area positioned within the housing 102 to the vending tray 110. The consumer can then remove the media storage unit 140 from the vending tray 110.

FIG. 1B illustrates how a payment is made in the media vending machine 100. Further, the mechanics of how the payment receiver 108 operates is well known in the art. The payment receiver 108 receives a payment from the user prior to the user pressing one of the plurality of actuators 104 to make a selection of a media storage unit 140. After the correct payment has been received, internal circuitry positioned within the housing 102 allows the media storage unit 140 associated with the actuator 104 that the user presses to be delivered to the vending tray 110. The payment receiver 108 can receive different forms of payment. In one embodiment, the payment receiver 108 receives a cash payment 133. The user can provide change through a change slot 134. The remaining change after purchase is distributed through a change tray 136. The user can press a change button 135 to receive change from the change tray 136. In another embodiment, the payment receiver 108 receives an electronic payment such as that of a Debit Card or a Credit Card.

In one embodiment, a handheld electronic device 145 can be used in conjunction with a handheld signal window 137. The handheld electronic device 145 can be a personal digital assistant (“PDA”), cellular phone, etc. One embodiment provides for the using of the handheld electronic device 145 to make a selection of a media storage unit 140. The handheld signal window can have a port for receiving an electronic signal beamed to it from the handheld electronic device 145. A user can enter the choice of media storage units 140 into the handheld electronic device 145 and then beam the selection to the handheld signal window 137. Alternatively, the user's preferences can be stored into the handheld electronic device 145 so that the user just has to walk by the handheld signal window 137 for the selection to be made without the user's prompt. For example, the user can store a preference in the handheld electronic device 145 for a particular CD. After the user walks by the media vending machine 100 housing that particular CD, the handheld electronic device 145 can beep so that the user knows that the CD is present within the media vending machine 100 without the user even having to look at the media vending machine 100. The handheld electronic device 145 can select the CD for the user so that the user only has to arrange for payment. In yet another embodiment, the payment receiver 108 receives a signal from the handheld electronic device 145 with payment instructions through the handheld signal window 137. In yet another embodiment the user receives an advertisement related to or possibly not related to a media storage unit as the user walks by the media vending machine 100. The advertisements are related to the user's preferences as stored in the handheld electronic device 145.

Further, the payment receiver 108 can accept a promotion generated coupon 132 as at least partial payment for the media storage unit 140. For example, when a consumer purchases a product from a grocery store, the grocery store can provide a coupon for purchase of a media storage unit 140. A grocery store would advantageously be inclined to provide promotion generated coupons because consumers would then be more inclined to return to the grocery store to purchase other grocery store items while using a coupon at the media vending machine 100. The consumer is not necessarily limited using the promotion generated coupon in that particular store. The promotion generated coupon 132 can be configured for use in remote stores or locations that are not even necessarily in a related industry to the store in which the media vending machine 100 is positioned. Retail stores would also benefit in a similar way by offering promotion generated coupons. The coupon 132 that the media vending machine 100 accepts can also be a prize redemption ticket. For instance, if a consumer plays a video game at an arcade, the consumer could take the ticket that the consumer wins and get a discount at a media vending machine 100 possibly located within the arcade itself or within a remote grocery or retail store.

Conversely, the media vending machine 100 can also dispense a promotion generated coupon 132 after the consumer has made a purchase. The consumer can use the promotion generated coupon 132 to make a purchase at a grocery store or retail location. The media storage units 140 can be sold at a higher volume because there is more incentive for consumers to purchase the media storage units 140. The consumers not only receive the media storage unit 140 of their choosing but also a discount on a product within a store location. The promotion generated 132 coupons are not limited to stores and can be used for purchases at food stands, other vending machines, and any other site where products, service, or food is sold. The media vending machine 100 can also provide prize redemption tickets so that a consumer can acquire a free prize or receive a discount on a prize at the retail store location or at some other location. For instance, the consumer could possibly win a free roll of film by taking the ticket he or she won from the media vending machine 100 located in the grocery store to a camera shop that will redeem the ticket. The camera shop's name could be printed on the ticket itself. The prize redemption ticket can also be a coupon or a full ticket to an event such as a concert. The consumer can take the prize redemption ticket to another location to redeem the concert ticket or possibly go directly to the concert with the prize redemption ticket. In one embodiment the promotion generated coupon is dispensed through a dispenser operably connected to the housing 102. In yet another embodiment, the promotion generated coupon can be adhered to a media storage unit 140 dispensed from the media vending machine 100.

In one embodiment, the promotion generated coupons 132 can even be used to purchase other media storage units 140 from the media vending machine 100. For instance, a consumer can collect a certain number of coupons that provide a discount or even a free media storage unit 140. The promotion generated coupons 132 can also provide the consumer with the ability to possibly purchase a media storage unit 140 at a future date at a discount.

Through the use of cross promotions, both retail stores and the media vending machine 100 operators can attract customers. Retail store consumers are encouraged to purchase a media storage unit 140 at the media vending machine 100 by providing the consumer with a coupon for the media storage unit 140. Purchasers of media storage units 140 are encouraged to purchase retail store products by receiving coupons for the retail store when purchasing a media storage unit 140.

The media vending machine 100 also includes an advertisement panel 112. In one embodiment, the advertisement panel 112 is a window in which an advertisement can be placed. The advertisement can relate to media storage units 140 or products not sold within the media vending machine 100. The advertisement can be related to services. In another embodiment, an advertisement can be adhered to the advertisement panel 112. The advertisement can be pasted with glue or adhered with any other known adhesive to the advertisement panel 112. In another embodiment, the advertisement panel 112 is a plastic advertisement panel that is adhered to the housing 102 with screws, magnets, nails, pins, bolts, static electricity or any other adhering mechanism. In yet another embodiment, the advertisement panel 112 has a receptacle in which the advertisement can be placed. The opening of the receptacle can be located on the top, bottom, or sides of the advertisement panel 112. In yet another embodiment, a liquid crystal or plasma display is used to display an advertisement. The liquid crystal or plasma display can alternate between advertisements. The liquid crystal display or plasma display can be connected to a host computer which provides the images to be inputted to the liquid crystal or plasma display.

FIG. 1C illustrates an embodiment of the actuator 104. The actuator 104 can be a button which is a housing that receives the actuator image 106 through a receptacle 172. The opening of the receptacle 172 is not limited to an opening on the top of the actuator 104. The actuator 104 can have the opening of the receptacle 172 on the bottom or sides as well. In one embodiment, the actuator 104 has hinges so that the front of the actuator 104 can be opened to place the actuator image 106. In yet another embodiment, a liquid crystal or plasma display is used to display an image for the actuator image 106.

FIG. 1D illustrates another embodiment of the media vending machine 100 in which an advertisement can be placed in the advertisement panel 112. A door 114 located in the front portion of the media vending machine 100 can be opened so that an advertisement can be placed on an inside panel 116 positioned on the inside of the door 114. The advertisement can be adhered to the inside panel 116 with a plurality of adhering mechanisms 118. The adhering mechanism can be a clip so that an advertisement can easily be replaced by unclipping the advertisement and clipping a new advertisement. In another embodiment, the adhering mechanism is a thumb tack. In yet another embodiment, the adhering mechanism is VELCRO®. In yet another embodiment, glue or another adhesive known in the art is used. In yet another embodiment, the inside panel has a receptacle with an opening in the top, bottom or sides for the advertisement to be slid into the inside panel 116. In yet another embodiment, the adhering mechanism is static electricity.

Further, FIG. 1D also illustrates the placement of the media storage units 140 on shelves 142. Holders 144 are used to hold the media storage units 140 in place. The holders 144 can be spirals or any other holders known to one of ordinary skill in the art. The controller 165 is operably connected to the plurality of actuators 104 (FIG. 1A) and a delivery promulgator 144 connected to the shelves that delivers the media storage unit 140 to the vending tray 110 upon the user's selection of an actuator 104.

The advertisement placed in the advertisement panel 112 can be an advertisement for a media storage unit 140 housed within the housing 102. Similarly, the advertisement can be for the artist of a media storage unit 140 housed within the housing 102. The concert date for the artist can, for example, be advertised in the advertisement. On the other hand, the advertisement may be for a product, service, or event that is not related to any of the media storage units 140 located within the housing 102. Further, the advertisement panel 112 is not limited to only displaying one advertisement. Rather, the advertisement panel 112 can be configured to display multiple or electronically “rolling” advertisements.

FIG. 1E illustrates yet another embodiment of the media vending machine 100 in which the plurality of actuators 104 are operably connected to a surface 150 that protrudes from the housing 102. The surface 150 can be a variety of shapes and can extend from the housing 102 at a variety of angles. Further, advertising can be placed on a side panel 402. Alternatively, there can be two side panels 402, each of which advertisements can be positioned in or on.

FIG. 1F illustrates yet another embodiment of the media vending machine 100 in which selection buttons 180 are operably connected to the housing 102. When a user activates one of the selection buttons 180, a corresponding image for the media storage unit 140 is displayed in a display window 181. The display window 181 can display a video image, a paper image that is rolled along a rolling mechanism, or any other way of providing an image corresponding to the media storage unit 140. In another embodiment, the selection buttons 180 are video buttons that appear within the display window 181. The user can touch the portion of the display window 180 to make a selection.

FIG. 1G illustrates yet another embodiment of the media vending machine 100 in which selection levers 182 are operably connected to the media vending machine 100. The selection levers 182 are used to select media storage units 140 corresponding to media storage unit displays 183. An image corresponding to a media storage unit 140 can be positioned within the media storage unit display 183 in a similar fashion to the manner in which the housing receives the actuator image 106 through the receptacle 172 as illustrated in FIG. 1C.

FIG. 1H illustrates yet another embodiment of the media vending machine 100 in which a dial 184 is used to make a selection of the media storage unit 140. The user can turn the dial 184 with a turn actuator 188. The dial 184 has dial sections 185, each of which has an image 186 operably connected to it. The image 186 corresponds to the media storage unit 140 in which the user wishes to make a selection. The user turns the turn actuator 188 so that the image that the user wishes to select is positioned underneath a selection arrow 187. After the user has made the selection, he or she then presses a selection button 170 to indicate which media storage 140 unit the user wishes to purchase. The user will then proceed to making a payment as described in FIG. 1B. Alternatively, the dial 184 can remain fixed and the selection arrow 187 can be positioned on the turn actuator 188 so that the turn actuator 188 can rotate with respect to the dial 184. After the user rotates the turn actuator 188 to the image 186, the user then presses the selection button 170. The selection button 170 does not necessarily have to be a button. The selection button 170 can be a lever or any other kind of actuator that allows the user to select the media storage unit that the consumer would like to purchase.

FIG. 1I illustrates another embodiment of the media vending machine 100 in which a dial 184 is used to make a selection of the media storage unit 140 with a display screen 189. The user can turn the dial 190 with a turn actuator 193. The dial 190 has dial sections 185, each of which has a marker attached to the respective dial section 185. For instance, the dial section 185 can have a letter marker such as the letter “A”, a numeric marker, a symbolic marker, a pictorial marker, or any other marker indicating which section of the dial 190 the user can possibly make a selection for a media storage unit 140. The dial section 185 corresponds to the media storage unit 140 in which the user wishes to make a selection. The user turns the turn actuator 188 so that the dial section 185 that the user wishes to view is positioned underneath a selection arrow 191. As the user turns the turn actuator 188, different images are displayed in the display window 189 corresponding to a media storage unit 140. The display window 189 can display video images or can display paper images. The paper images can rotate about a rolling mechanism positioned within the media vending machine 100. After the user has made the selection, he or she then presses a selection button 170 to indicate which media storage unit the user wishes to purchase. The user will then proceed to making a payment as described in FIG. 1B. Alternatively, the dial 190 can remain fixed and the selection arrow 191 can be positioned on the turn actuator 193 so that the turn actuator 193 can rotate with respect to the dial 190. After the user rotates the turn actuator 193 to the image 186, the user then presses the selection button 170. The selection button 170 does not necessarily have to be a button. The selection button 170 can be a lever or any other kind of actuator that allows the user to select the media storage unit that the consumer would like to purchase.

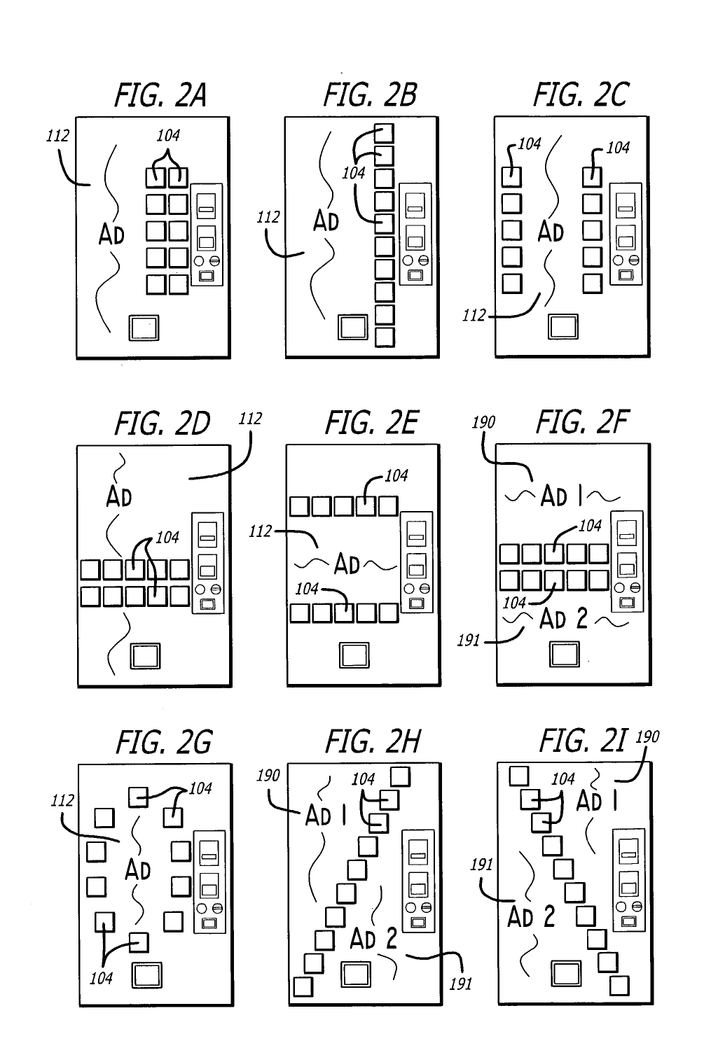

FIGS. 2A-2I illustrate different arrangements for the plurality of actuators 104. Within each of the arrangements, the plurality of actuators 104 are positioned so as to give the impression that the media storage units are ranked. In one embodiment, numerals representing the rankings appear within the vicinity of the plurality of actuators 104.

FIG. 2A illustrates an arrangement wherein the plurality of actuators 104 are arranged in columns. A consumer viewing this arrangement would likely get the impression that the top row of the columns represented the most popular media storage units 140 where as the lowest row in the columns represents the least popular media storage units 140. FIG. 2B illustrates a similar arrangement as that of 2A with one column. FIG. 2C represents a similar arrangement as that of 2A with the advertisement panel 112 positioned in between the columns. FIG. 2D illustrates a similar arrangement to that of FIG. 2A with more rows than columns. FIG. 2E represents a similar arrangement to that of FIG. 2C with the advertisement panel 112 positioned in between.the rows.

FIGS. 2F-2I illustrate arrangements of the actuators 104 with multiple advertisement panels 112. FIG. 2F illustrates the plurality of actuators 104 arranged in rows with an advertisement panel 112 positioned above the rows and an advertisement panel 112 positioned below the rows. FIG. 2G illustrates the plurality of actuators 104 arranged in a circle. The advertisement panel 112 is positioned within the circle. Similarly, a second advertisement panel 112 can be positioned outside the circle. FIG. 2H illustrates a diagonal arrangement of the plurality of actuators 104. A first advertisement panel 112 can be placed above the plurality of actuators 104, and a second advertisement panel can be placed below the plurality of actuators 104. FIG. 2I represents the arrangement of the plurality of actuators 104 illustrated in FIG. 2H with the diagonal positioned in a different direction.

One of ordinary skill in the art will recognize that the plurality of actuators 104 can include a different number of actuators from those shown and can be arranged in different arrangements from those shown. For instance, the plurality of actuators 104 may include twenty actuators as opposed to ten actuators. Further, the plurality of actuators can be arranged in different numbers or row and columns or different shapes such as squares, rectangles, and triangles. Further, the plurality of actuators 104 can have different sizes. The consumer may get the impression that the largest actuator 104 corresponds to the most popular media storage unit 140 and that the smallest actuator 104 corresponds to the smallest media storage unit 140.

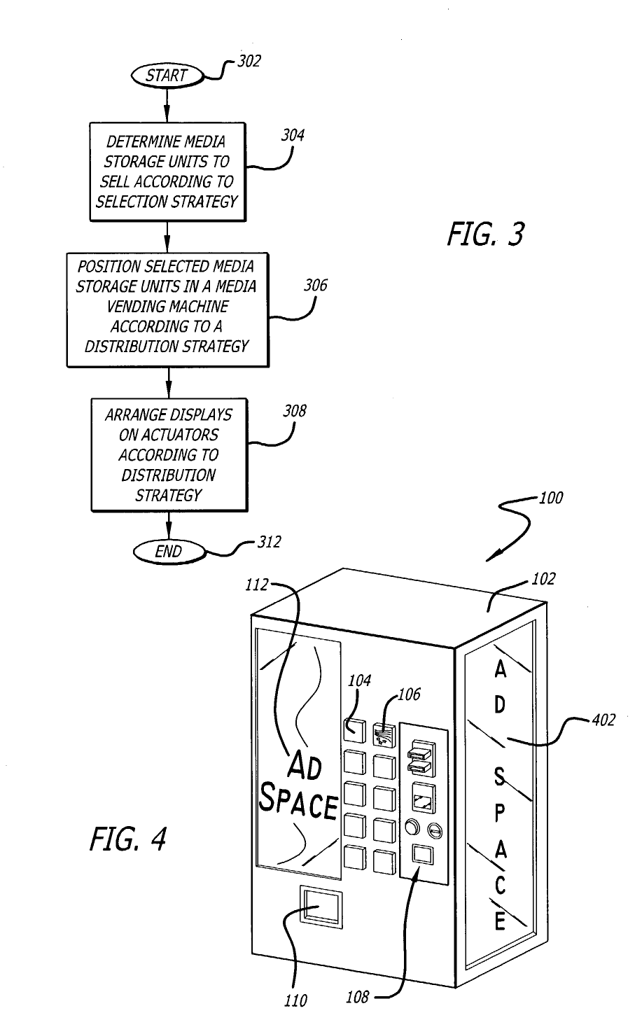

FIG. 3 illustrates a process 300 for using the media vending machine 100 (FIG. 1). The process begins at a process block 302. The process advances to a process block 304 where the media storage units 140 to be sold are determined according to a selection strategy. The determination of what media storage units are placed in the media vending machine 100 (FIG. 1) can be determined by popularity rankings of media storage units 140 published by, for example, Billboard, Inc. In another embodiment, the popularity rankings are determined by sales of the most popular media storage units based on analysis of demographic statistics. In this embodiment, the popularity of the media storage units is measured for the geographic location in which the media vending machine 100 (FIG. 1) is placed. For example, the selection strategy for a media vending machine 100 (FIG. 1) placed in a grocery store located in West Los Angeles may be different from the selection strategy for a media vending machine 100 (FIG. 1) placed in a grocery store in East Los Angeles.

Popularity for media storage units that are CD's can be determined by using a demographics analysis service, such as, for example, SoundScan, Inc. The demographics analysis service can provide popularity rankings for music within a geographic area such as a city or a section of a city. In one embodiment, the demographics analysis service can conduct polling within a small setting such as a high school, college, or university. The demographics analysis service can provide the demographics analysis based on methods such as, for example, conducting surveys of people.

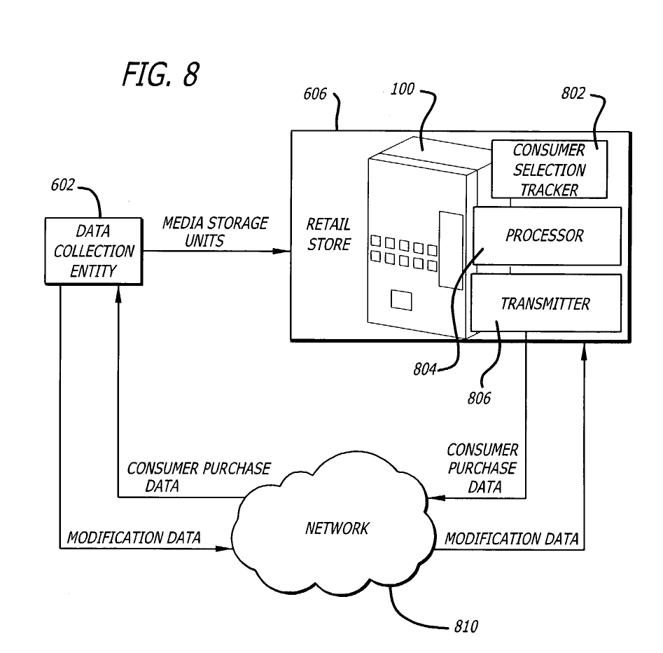

In another embodiment, popularity of the media storage units is determined by a counter residing within the media vending machine 100 (FIG. 1). The counter can also be called a consumers' selection tracker (FIG. 8). The counter records the purchases of media storage units 140. The counter can be checked by physical inspection. Alternatively, the data recorded by the counter can be transmitted through a wireless or other electronic connection to a host computer or data center. The data recorded by the counter can be used to determine the arrangement of the actuator images 106 on the plurality of actuators 104. For instance, if the data indicate that more consumers are purchasing a media storage unit 140 correlating to a actuator image 106 positioned in a bottom row than a media storage unit 140 correlating to a actuator image 106 positioned in a top row, then the actuator image 106 positioned in the bottom row can be moved to the top row while the actuator image 106 positioned in the top row can be positioned within the bottom row. The media storage units can be operably positioned in the housing 102 to reflect the change in position of the correlating actuator image 106. Further, this data can be helpful in determining the type of media storage unit that is popular within a particular demographic area. For example, if the counter data indicate that Rock CD's are selling quite well in comparison to Jazz CD's in a particular city, then the media vending machine 100 (FIG. 1) should possibly be geared towards selling only the most popular Rock CD's. Therefore, the media vending machine 100 can be used advantageously to both distribute the most popular media storage units 140 and measure how popular media storage units 140 are.

Further, the placement of actuator images 106 can influence the taste of consumers. If a consumer perceives that a media storage unit 140 is very popular because of a higher positioning of the actuator image 106 relative to other actuator images 106, the consumer may purchase a media storage unit 140 that the consumer would not otherwise be inclined to purchase. It is well known in the art that popularity rankings of media storage units such as CD's have an enormous impact on CD sales. Many consumers would like to purchase not necessarily what they like but rather what they perceive as being the most popular. In addition, consumers many times buy products more for the way the product is advertised rather than the quality or type of the product. Advertisers can pay to have advertisements placed in the advertisement panel 112 so that a media storage unit placed within the housing 102 is sold. Therefore, the media vending machine 100 can also be a vehicle through which advertisers influence the popularity of a media storage unit.

In one embodiment, the media storage units are changed after a time period elapses based on the new popularity rankings. The door 114 can be opened so that the media storage units can be reoriented within the housing 102 to correlate with the position of the actuator 104 for which the media storage unit 140 is placed. The actuator image can be changed as well to match the associated actuator 104. In many instances, previously popular media storage units 140 will be removed because they are no longer one of the most popular media storage units. Further, new media storage units will become popular and will have to be added. In yet another embodiment, a host computer communicates with a process located within the media vending machine 100 to change the actuator images 106 displayed on a computer generated display to reflect changes in popularity. Further, the host computer instructs the media vending machine's processor to reorient the connection between the actuators 104 and the placement of the media storage units within the housing 102.

The process then proceeds to a process block 306 where the media storage units 140 are positioned in a media vending machine. The positioning of the media storage units is based on a distribution strategy. In one embodiment, the distribution strategy is to arrange the media storage units selected in the process block 304 according to the most popular media storage units. Popularity can be determined by one of the methods discussed above. Alternatively, the distribution strategy can be to arrange the media storage units to market the media storage units. For instance, a CD performed by a new or unknown artist can be placed at a high position within the plurality of actuators 104 in order to influence potential consumers. Similarly, advertisements for the new or unknown artist can be placed in the advertisement panel 112.

The process proceeds to a process block 308 where the plurality of actuators 104 is provided for selection of a media storage unit 140. The media storage units 140 are arranged within the housing to correlate to the plurality of actuators 104. The process proceeds to a process block 310 where the actuator images 106 are arranged according to the distribution strategy discussed above. The process proceeds to a process block 312. The media vending machine 100 (FIG. 1) is now ready to be accessed by a consumer wishing to make a selection of a media storage unit.

FIG. 4 illustrates another embodiment of the media vending machine 100 illustrated in FIG. 1. The media vending machine 100 illustrated in FIG. 4 has an advertisement side panel 402. Much like one embodiment of the advertisement panel 112, an advertisement can be placed within the advertisement side panel 402. The advertisement can be for a media storage unit 140 housed within the media vending machine 100 or can be for a product or service not related to the media storage units housed within the media vending machine 100. In one embodiment, the advertisement side panel 402 displays an advertisement for a product, service, or event not related to a media storage unit housed within the housing 102 while the advertisement panel 112 displays an advertisement for a product, service or event that is related to a media storage unit housed within the housing 102 such as the media storage unit 140 itself. In yet another embodiment, the advertisement side panel 402 displays an advertisement for a product, service, or event that is related to a media storage unit 140 housed within the housing 102 such as the media storage unit 140 itself while the advertisement panel 112 displays an advertisement for a product, service or event that is not related to a media storage unit 140 housed within the housing 102. In yet another embodiment, neither the advertisement side panel 402 nor the advertisement panel 112 displays an advertisement for a product, service, or event that is related to a media storage unit 140 housed within the housing 102 but rather displays an advertisement for a product, service or event that is not related to a media storage unit 140 housed within the housing 102. Finally, in yet another embodiment, both the advertisement side panel 402 and the advertisement panel 112 display an advertisement for a product, service, or event that is related to a media storage unit 140 housed within the housing 102.

The advertisement side panel 402 can have a receptacle with an opening in the top, bottom, or side of the advertisement side panel 402 for the advertisement to be slid into. The advertisement can slide into the receptacle in a similar fashion to the button image 106 sliding into the receptacle 172 of the actuator 104 as illustrated in FIG. 1C. Alternatively, the advertisement can be adhered to the advertisement side panel 402 with the use of glue, screws, bolts, clips, nails, or any other adhering mechanism.

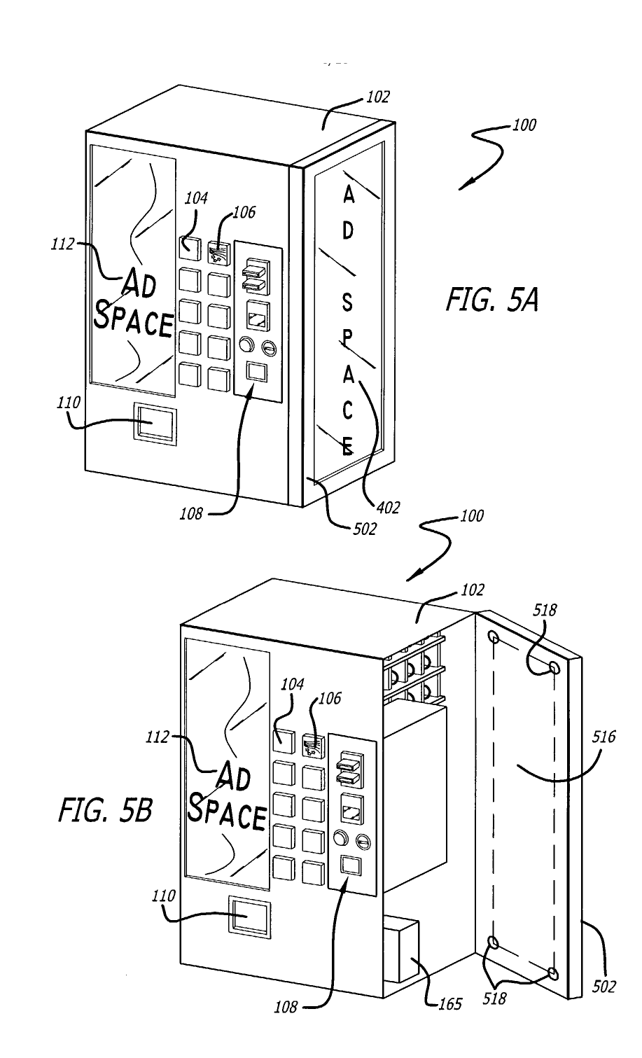

FIG. 5 illustrates another embodiment of the media vending machine 100 illustrated in FIG. 4. FIG. 5 illustrates a door 502 that can be opened for placement of the advertisement in the advertisement side panel 402. The advertisement can be adhered to the advertisement side panel 402 in a similar fashion to the advertisement being adhered to the advertisement plate 112 (FIG. 1).

In yet another embodiment, the advertisement side panel 402 can hold or provide one large display that rotates between multiple advertisements. In yet another embodiment, a liquid crystal or plasma display is used to display an advertisement. The liquid crystal or plasma display can alternate between advertisements. The liquid crystal display or plasma display can be connected to a host computer which provides the images to be inputted to the liquid crystal or plasma display.

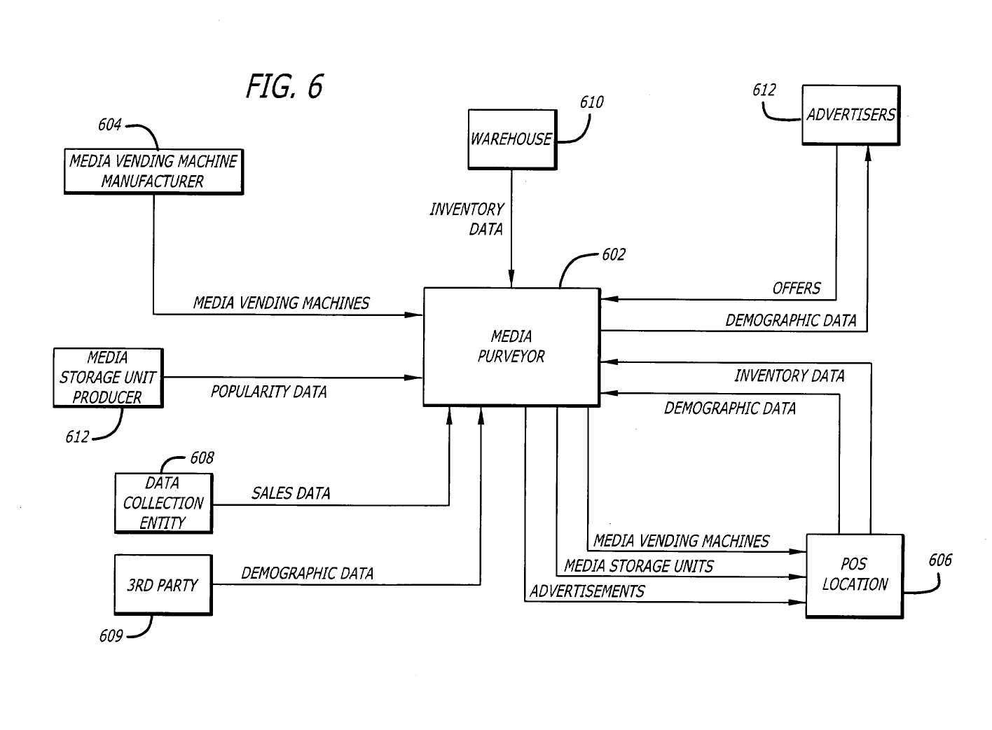

FIG. 6 illustrates a block diagram of an integrated distribution network for media storage units and changeable advertising. A media purveyor 602 coordinates the flow of data and products amongst a variety of different entities. The media purveyor 602 can use a computer to coordinate this data. Alternatively, the media purveyor 602 can be a computer system itself. The media purveyor 602 arranges for the purchase of media vending machines 100 from a media vending machine manufacturer 604. The media purveyor 602 determines the number of media vending machines 100 it needs in addition to the specific requirements that it needs for the media vending machines 100. The vendors will be operating the media vending machines 100 at one or more POS (Point of Sale) locations 606. Different contractual relationships such as purchase or leasing the media vending machines 100 can be arranged between the media purveyor 602 and the vendors operating the media vending machines 100 at the POS locations 606. The media purveyor can require that the vendors provide royalties based on the sales in the media vending machines 100. As will be discussed below, the media purveyor 602 can train the vendors how to operate, service, and maintain the media vending machines 100. The vendors may be required to pay an additional fee for the training, or the training may be part of the contractual relationship.

A media storage unit producer 607 provides popularity data to the media purveyor 602. The media storage unit producer 607 can be a record label, record supplier, DVD supplier, computer software supplier, or any other manufacturer of supplier of media storage units 140. The media storage unit producer 607 initially supplies the media purveyor 602 with popularity data. The popularity data can be pre-order projections of the popularity of a media storage unit 140 that assists the media purveyor in making a determination of whether to purchase the media storage unit 140. The media storage unit producer 607 can base the projected sales of a media storage unit 140 on past sales of media storage units 140 recorded by the same or a similar artist in the case of a music media storage unit 140. The media storage unit producer 607 can use other criteria such as past sales of media storage units 140 produced by the same producer, director, etc.

The media storage unit producer 607 is one example of an information source that provides popularity data to the media purveyor 602. Other information sources can be popularity rankings that are published, broadcast on the radio, televised, or posted on the Internet. For instance, the popularity ranking can be a top ten countdown aired on MTV®.

In addition, the media purveyor 602 can collect data from other sources and perform its own internal analysis to decide whether to obtain media storage units 140. In one embodiment, the media purveyor 602 obtains the media storage units 140 by purchasing the media storage units 140 from the media storage unit producer 607 or from another entity selling the media storage units 140. In another embodiment, the media purveyor 602 obtains the media storage units 140 in an arrangement such as consignment. For example, the media purveyor 602 can receive the media storage units 140 and only pay the media storage unit producer 607 based on the number of media storage units 140 actually sold and return the rest. A data collection entity 608 provides the media purveyor with sales data indicating past consumer demand for media storage units 140 within a geographic region. Further, the media purveyor 602 can receive demographic data from the POS location. By determining the demographics for a particular location, the media purveyor 602 can better determine whether to obtain media storage units 140 for a particular geographic location. For instance, a CD may be on top of the Billboard charts nationally but may not be popular in a small town. In addition, the media purveyor 602 can receive demographic data from a third party. For instance, if the media vending machine 100 is going to be located in a retail store, demographic data from a local fast food restaurant will also be of assistance to the media purveyor 602 in determining consumer taste for a POS location 606. The demographic data can include attributes of a consumer such as age, wealth, education, and ethnic background.

Once the media purveyor 602 receives all the data, the media purveyor 602 performs its own internal analysis on the data received. The media purveyor 602 can store its own data in addition to the data it receives. For instance, the media purveyor 602 can record the consumer spending habits at the media vending machines 100 as through a consumer selection tracker (FIG. 8C). The media purveyor 602 can have the vendors physically inspect the media vending machines 100 to make physical records. The physical records can be produced by recording the initial number of media storage units 100 placed in the media vending machine 100 versus the present number of media storage units 100. For example, if ten CD's for a particular artist were placed in the media vending machine 100 yesterday, and only two are present today, then the vendors can make a record of eight CD's being sold for that particular artist within the time span of one day. Before the placement of a media vending machine 100 in a POS location 606, the media purveyor 602 may need to depend on much of the data it receives. However, after the placement of the media vending machine 100 at a POS location 606, the media purveyor 602 can use more of its own data and less external data. For instance, the media purveyor 602 can rely more on its own projected sales of a media storage unit 140 and less on the popularity data it receives from the media storage unit producer 607. The media purveyor 602 can choose to use some of the data it receives and discard other data. For instance, the media purveyor 602 may want to use its own projected sales data as opposed to projected sales data from the media storage unit producer 607 but may still choose to use demographic data from the POS location 606.

Prior to ordering any media storage units 140, the media purveyor 602 receives inventory data from a warehouse 610. The media purveyor 602 uses the inventory data to determine if the media purveyor 602 already has the media storage units 140 present within its inventory. If the media purveyor 602 has the media storage units 140 present within the warehouse 610, then the media purveyor 602 does not have to make a purchase from the media storage unit producer 607 unless the media purveyor's 602 analysis indicates a projected demand for the media storage units 140, in which case the media purveyor 602 will want to purchase additional inventory. If the media purveyor 602 does not have the media storage units 140 present within the warehouse 610, then the media purveyor 602 will want to make a purchase of media storage units 140 from the media storage unit producer 607.

The media purveyor 602 provides the demographic data to advertisers 612 to assist the advertisers in composing offers for advertising space on the media vending machine 100. The advertisers 612 use the demographic data to learn what type of audience the product or service being advertised is reaching. If the audience for the given POS location 606 corresponds to the audience that the advertisers are directing their advertising to, then the advertisers will likely be more willing to place a higher offer for advertising on the media vending machine 100 in that given POS location 606 than if the audience did not correspond to the directed audience. The advertisers 612 send their offers to the media purveyor 602. The media purveyor 602 collects the offers and determines which advertisers it will provide advertising space on the media vending machine 100 to. In one embodiment, this determination is simply based on the advertiser that provides the highest offer. In another embodiment, the determination of which advertiser wins the bidding process is determined by the media purveyor's 602 analysis of which advertiser will increase sales of media storage units 140.

The media purveyor 602 coordinates many functions and can perform some of those functions as well. Therefore, the media purveyor 602 can perform some or all of the roles of the vending machine manufacturers 604, the media storage unit producers 607, or the media advertisers 612. The media purveyor 602 advantageously overcomes the problems in the present state of the art by giving media suppliers access to POS locations 606 in locations that consumers necessarily frequent. Many consumers are reluctant to travel all the way to, for instance, a record store just to purchase a CD. However, consumers would likely purchase media storage units, such as, for example, CD's if the CD's were placed in a convenient location that tapped into the buy impulse of most consumers. The POS locations 606 include but are not limited to airports, car washes, grocery stores, hospitals, amusement parks, health clubs, service stations, retail stores, video stores, bars, banks, beauty salons, etc. The media purveyor 602 advantageously provides advertisers with more direct contact with the consumer. In essence, the media vending machine 100 (FIG. 1) provides the consumer with an eye level view of a billboard. Consumers can see these advertisements up close when carrying out their every day routines such as going to the grocery store, car wash, airport, etc. Finally, the vending industry is provided with a vast new market of products and a whole new look that will bolster the vending industry.

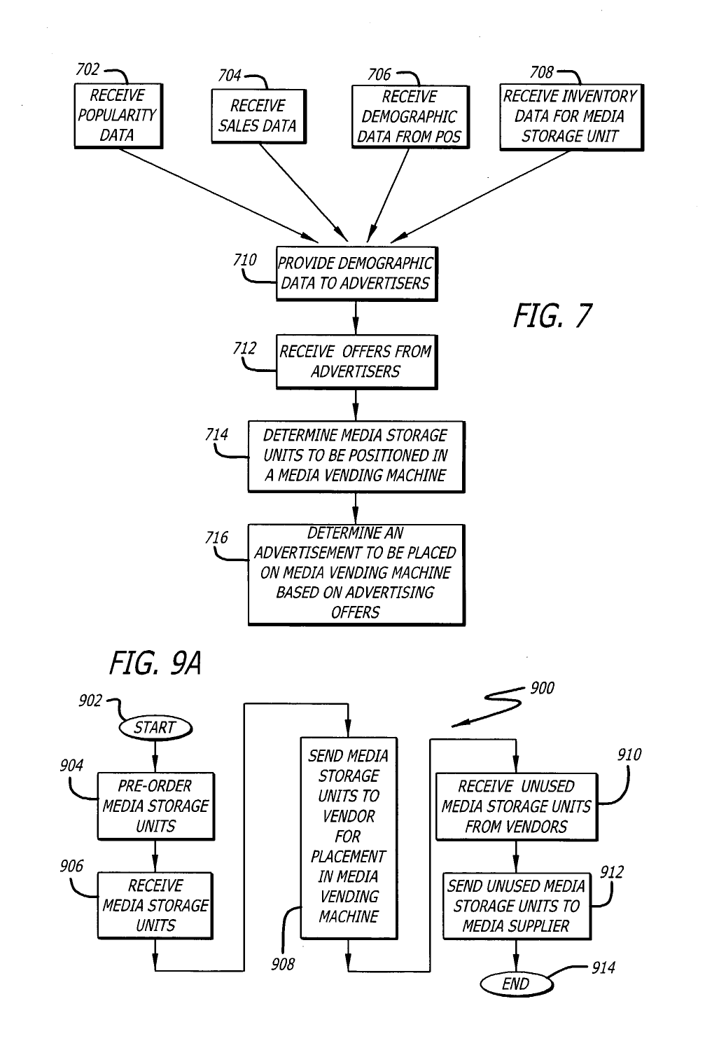

FIG. 7 illustrates a process for the media purveyor 602 for coordinating data, distributing media storage units, and determining advertising between the entities described in FIG. 6. At a process block 702, the media purveyor 602 receives popularity data. As discussed above, the media purveyor 602 can receive the popularity data from the media storage unit producer 607. The popularity data can be projected sales for media storage units 140 that have not been released yet. Alternatively, the popularity data can be actual sales for media storage units 140 that have already been released. At a process block 704, the media purveyor 602 receives sales data. The sales data can be for a geographic region. Further, the sales data can come from the data collection entity 608. At a process block 706, the media purveyor 602 receives demographic data from a POS. A retailer or other entity in which the POS is located can provide the demographic data if it is recorded. Optionally, at a process block 708, the media purveyor 602 receives inventory data for a media storage unit 140 from the warehouse 610 associated with the media purveyor 602. The inventory data assists the media purveyor 602 in determining whether to purchase media storage units 140. The media purveyor 602 can house its own inventory on-site rather than receive inventory data from the warehouse 610. Alternatively, the media purveyor 602 can both house inventory on-site and at a warehouse. The process blocks 702, 704, 706, and 708 can occur simultaneously or in any order. The process then proceeds to a process block 710 where the media purveyor 602 provides the demographic data to advertisers. After the advertisers review the demographic data, at a process block 712 the media purveyor 602 receives offers from advertisers. Next, at a process block 714, the media purveyor 602 determines media storage units to be positioned in a media vending machine. Finally, at a process block 716 the media purveyor 602 determines an advertisement to be placed on the media vending machine 100.

FIG. 8 illustrates the integrated distribution network illustrated in FIG. 6 with the addition of a network 810 that the media purveyor can use to send to and receive data from the POS 606. For instance, the POS 606 can be a retail store with a media vending machine 100 located at the retail store. The retail store will receive media storage units 140 from the media purveyor 602 to place in the media vending machine 100. Employees at the retail store or vendors servicing the media vending machine 100 can place the media storage units 140 within the media vending machine 100. Within the media vending machine resides a consumer selection tracker 802, which counts the number of the different media storage units 140 purchased. In one embodiment, the consumer selection tracker 802 is housed to the exterior of the media vending machine 100. A processor 804 is housed within the media vending machine 100. The processor 804 tabulates the data recorded by the consumer selection tracker 802 and uses a transmitter also housed within the media vending machine 100 to send the consumer purchase data to the media purveyor 602 through the network 810. The network can be a local area network (LAN), the internet, or any other network configuration known to one of ordinary skill in the art. The media vending machine 100 can itself be part of a LAN which also includes a remote computer for direct communication between the processor 804 in the media vending machine 100 and a server on the remote computer. Telemetry can be used for data mining. Data can be transmitted through a telephone network, such as PSTN, received, and stored to determine tastes and habits of a consumer. The time of the day that a consumer purchases a particular type of media storage unit can be recorded. The data mining may provide information such as the type of music that consumers buy in the morning versus the afternoon. If the data mining reveals that consumers buy substantially more rock music in the morning than R&B, then arrangement of the actuator images 106 can be switched in the morning to reflect those tastes. Further, if R&B media storage units tend to be more popular in the afternoon, the actuator images 106 can be re-arranged in the afternoon to reflect those tastes.

In one embodiment, the media purveyor 602 can send modification data through the network 810 to the POS 606. The modification data can include instructions to change the arrangement of the actuator images 106 based on the consumer purchase data that the media purveyor 602 receives. In one embodiment, the instructions can be viewed at the media vending machine 100. A computer screen positioned on the media vending machine 100 would provide the instructions to the vendor or POS employee. The instructions can be sent via e-mail or a simple text message. The vendors or the POS employees can read the instructions and change the arrangement of the actuator images 106. In one embodiment, the instructions can be viewed at a location at the POS 606 connected to the network 810 other than the media vending machine 100. One example of another location at the POS 606 site would be a computer set up at a counter separate from the media vending machine 100. In one embodiment, the instructions can be printed out off the media vending machine 100 or off the alternate location.

Alternatively, media purveyor 602 can visit the POS 606 to view the number on the counter. In one embodiment, the media purveyor 602 can use a handheld electronic device 145 to download the data from the media vending machine 100 which includes the number of media storage units purchased. In another embodiment, the vendors or POS 606 employees that maintain the media vending machine 100 physically inspect the media vending machine 100 and transmit the data to the media purveyor 602. The vendors or POS 606 employees can alternatively send the data to the media purveyor 602 through a network other than the network 810.

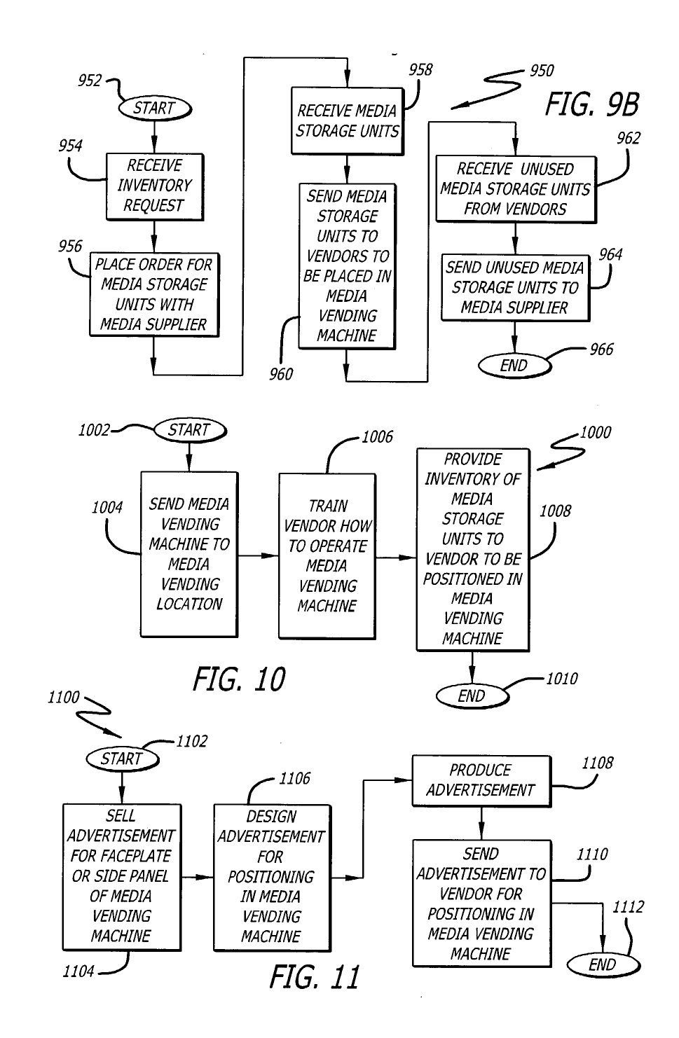

FIG. 9A illustrates a process 900 in which the media purveyor 602 can coordinate with vendors with respect to stocking and maintenance of the media vending machine 100. The process begins at a process block 902. At a process block 904, the media purveyor 602 pre-orders media storage units 140 for the media vending machine 100. The pre-order can be based on predicting the taste for a given demographic area. The use of the consumer selection tracker or a demographics analysis service can assist the media purveyor 602 in making the prediction of what media storage units 140 and how many media storage units to preorder. In a process block 906, the media purveyor 602 receives the media storage units. In a process block 908, the media purveyor 602 sends the media storage units to the vendors for placement in the media vending machine 100. In another embodiment, other individuals or entities other than the vendors can place the media storage units in the media vending machine. For instance, it is possible that grocery store employees would place the media storage units 140 in the media vending machine.100. At a process block 910, the media purveyor 602 receives unused media storage units from the vendors. After a period of time elapses, some of the media storage units may not have been sold because they were unpopular. The vendors can then send those unused media storage units back to the media purveyor 602. At a process block 912, the media purveyor 602 can send the unused media storage units back to the media supplier possibly for a refund or to third parties for resale. At a process block 914, the process ends.

FIG. 9B illustrates a process 950 similar to that of FIG. 9A but where the media storage units 140 have already been pre-ordered. The process begins at a process block 952. At intermittent time periods, the inventory is checked. The most popular CD's sometimes run out of stock. At a process block 954, the media purveyor 602 receives an inventory request. The inventory request can come through a telephone, land line, wireless, DSL, cable modem, or any other network connection from a processor located within the media vending machine 100 to a host computer that is accessible by the media purveyor 602 or from a manual inspection. The processor can keep track of the inventory count of the different media storage units. When the inventory for any given media storage unit 140 reaches a certain threshold level, e.g. only five remaining CD's, then a warning signal can be triggered to send an inventory request to the media purveyor 602. Alternatively, the media purveyor 602 can receive the request from the vendors that monitor the inventory. At a process block 956, the media purveyor 602 can place an inventory request with the media supplier 706 to restock the inventory for the media storage unit. The media purveyor 602 may choose not to restock the media storage unit if the media storage unit 140 is no longer deemed popular by popularity rankings, does not have advertiser backing, or took too long a time period to reach the threshold level signaling lack of consumer demand possibly within the given geographic location, or for other considerations, such as, for example, financial factors, promotions, etc. At a process block 958, the media purveyor 602 receives the media storage units. In a process block 960, the media purveyor 602 sends the media storage units 140 to the vendors for placement in the media vending machine 100. In another embodiment, other individuals or entities other than the vendors can place the media storage units 140 in the media vending machine 100. At a process block 962, the media purveyor 602 receives unused media storage units 140 from the vendors. After a period of time elapses, some of the media storage units 140 may not have been sold because they were unpopular. The vendors can then send those unused media storage units 140 back to the media purveyor 602. At a process block 964, the media purveyor 602 can send the unused media storage units 140 back to the media supplier possibly for a refund or to third parties for resale. At a process block 966, the process ends.

FIG. 10 illustrates a process 1000 in which the media purveyor 602 (FIG. 6) works in conjunction with the vendors. At a process block 1002, the process begins. At a process block 1004, the media purveyor 602 or another entity can send the media vending machine 100 to a media vending location such as a POS 606. At a process block 1006, the media purveyor 602 trains a vendor to operate and maintain the media vending machine 100. The media purveyor 602 can teach the vendors how to stock, maintain, and service the media vending machine 100. At a process block 1008, the media purveyor 602 can provide media storage units to the vendors in order to be stocked in the media vending machine 100. The process ends at a process block 1010.

FIG. 11 illustrates a process 1100 in which the media purveyor 602 (FIG. 6) works in coordination with media advertisers 612 (FIG. 6). The process begins at a process block 1102. The process then advances to a process block 1104 in which the media purveyor 602 sells advertisements for faceplate, side panel, top, or back of the media vending machine 100. At a process block 1106, the media purveyor 602 designs an advertisement for positioning the media storage units in the media vending machine 100. The design involves sizing the advertisement to fit the media vending machine 100. In one embodiment, the media purveyor 602 receives approval from the media advertisers 612. This approval can be sent electronically through a telephone, land line, wireless, DSL, or cable modem connection. At a process block 1108, the media purveyor 602 produces an advertisement. In one embodiment, the media purveyor 602 receives a finished advertising product from the advertiser. At a process block 1110, the media purveyor 602 sends the advertisement to the vendors for placement on or in the media vending machine 100. Alternatively, the media purveyor 602 or some other entity may place the advertisement on or in the media vending machine 100.

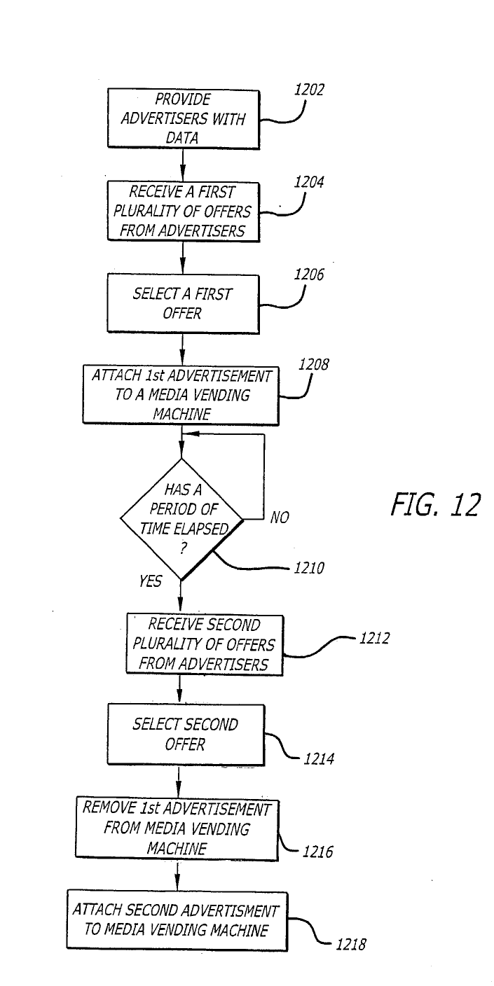

FIG. 12 illustrates a process for changeable advertising on the media vending machine 100. At a process block 1202, the media purveyor 602 provides advertisers with data. This data can include demographics data or other data that the media purveyor 602 can provide to the advertisers to help determine how much of an offer, if any, the advertisers would like to make for advertising space on the media vending machine 100. At a process block 1204, the media purveyor 602 receives a first plurality of offers from the advertisers. At a next process block 1206, the media purveyor 602 selects an offer. The media purveyor 602 can select the first offer on criteria such as, for example, the highest offer. Other criteria may include the relatedness of the advertisement to the media storage units 140 housed within the media vending machine 100, relatedness of the advertisement to products sold at the POS 606. Next, at a process block 1208 a first advertisement is attached to the media vending machine 100. The media purveyor 602 can physically attach the first advertisement to the media vending machine 100. Alternatively, the term “attach” can be construed as an instruction by the media purveyor 602 to attach the first advertisement. The media purveyor 602 can instruct vendors or POS 606 employees to attach the advertisement. Further, the manner of attaching the first advertisement is such that the first advertisement is operably connected to the media vending machine 100 (FIG. 1). In one embodiment, the advertisement is attached to the side advertisement panel 402 (FIG. 4A). Alternatively, the advertisement can be placed in the advertisement panel 112 (FIG. 1) Alternatively, the advertisement can be positioned on the top, bottom, or back of the media vending machine 100. In an alternative embodiment, the advertisement may be sent electronically to the media vending machine 100 to be displayed on a video, liquid crystal, or plasma display. As discussed above, the advertisement can be for advertising related to the media storage units 140 housed within the housing 102 (FIG. 1) or to a product, service, or event not related to a media storage unit housed within the housing 102 (FIG. 1).

At a decision block 1210, it is determined whether a period of time has elapsed. The period of time can include the time it takes to receive new popularity rankings, new data on popularity, a higher advertising offer from an advertiser, an advertising time period for an old advertisement to expire, etc. The time period can be a discretionary time period set by operators of the media vending machine 100 (FIG. 1). If the time period has not elapsed, the process returns to the decision block 1210 until the time period elapses. If the time period has elapsed, then the process proceeds to a process block 1212, where a second plurality of offers is received from advertisers. At a process block 1214, a second offer is selected in a similar manner to the selection of the first offer. Next, at a process block 1216, the first advertisement is removed from the media vending machine 100. Finally, at a process block 1218 the second advertisement is attached to the media vending machine 100 in a similar manner to that of the first advertisement. In another embodiment, the first advertisement can be removed before the second plurality of offers is received from advertisers.

While the above description contains many specifics, these should not be construed as limitations on the scope of the invention, but rather as an exemplification of preferred embodiments thereof. The invention includes any combination or subcombination of the elements from the different species and/or embodiments disclosed herein. One skilled in the art will recognize that these features, and thus the scope of the present invention, should be interpreted in light of the following claims and any equivalents thereto.

We claim:

1. A method for utilizing a media vending machine in a data communication network, comprising:
receiving popularity data setting forth popularity of a media storage unit;
receiving sales data for the media storage unit within a defined geographical area;
receiving demographic data of and from a point of sale location;
providing data to advertisers to assist the advertisers in preparing an offer for advertising space on the media vending machine positionable at the point of sale locations;
receiving offers from the advertisers for advertising space on the media vending machine;
determining the media storage units to be positioned for sale in the media vending machine based at least in part upon an analysis of the popularity data, the sales data, and the demographic data; and
determining an advertisement to be placed on the media vending machine based at least in part on the offers.

2. The method of claim 1, further comprising receiving inventory data for the media storage unit.

3. The method of claim 2, wherein the determining the media storage units is further based at least in part upon the analysis of the inventory data.

4. The method of claim 2, further comprising reconciling inventory of the media storage units based on the inventory data.

5. The method of claim 2, wherein the inventory data include the quantity of media storage units present within the media vending machine.

6. The method of claim 2, wherein the inventory data include the quantity of media storage units present at a location other than the media vending machine.

7. The method of claim 1, wherein the determining the advertisement is based at least in part on the relatedness of the media storage unit to the advertisement.

8. The method of claim 1, further comprising purchasing the media storage units to be positioned for sale in the media vending machine.

9. The method of claim 1, further comprising distributing the media storage units to a vendor for positioning for sale in the media vending machine.

10. The method of claim 1, further comprising distributing the media storage units to a stocker of media storage units for positioning for sale in the media vending machine.

11. The method of claim 1, further comprising distributing the media storage unit to a point of sale for positioning for sale in the media vending machine.

12. The method of claim 1, further comprising distributing the media storage unit to a retail store location for positioning for sale in the media vending machine.

13. The method of claim 1, wherein the determining the advertisement to be placed on the media vending machine is also based on the demographic data.

14. The method of claim 1, wherein the popularity data is based on a third party's published ranking of media storage units.

15. The method of claim 1, wherein the popularity data comprises projected popularity data.

16. The method of claim 1, wherein the defined geographical area is a city.

17. The method of claim 1, wherein the defined geographical area is a retail store.

18. The method of claim 1, wherein the demographic data includes attributes of customers making purchases at the point of sale location.

19. The method of claim 18, wherein the attributes include wealth of the customers making purchases at the point of sale location.

20. The method of claim 18, wherein the attributes include the age of customers making purchases at the point of sale location.

21. The method of claim 18, wherein the attributes include the ethnic background of customers making the purchases at the point of sale location.

22. The method of claim 1, wherein the media storage unit is a compact disc, a DVD, a video game, a VHS tape, a flash memory, or computer software.

23. A system which collects and analyzes data to determine a media storage unit to be distributed through a media distribution network for positioning in a media vending machine, comprising:
a media purveyor which receives popularity data from an information source providing information related to the media storage unit, receives sales data regarding the media storage unit within a geographic area from a data collection entity, receives demographic data from a point of sale location, provides data to advertisers to allow the advertisers to compose an offer for advertising space on the media vending machine, receives offers from advertisers for advertising space on the media vending machine, performs an analysis to determine what media storage units to obtain from the media storage unit producer, and obtains the media storage units from the media storage unit producer based upon the analysis.

24. The system of claim 23, wherein the obtaining of the media storage units is purchasing the media storage units.

25. The system of claim 23, wherein the obtaining of the media storage units is receiving the media storage units on consignment.

26. The system of claim 23, wherein the information source is a media storage unit producer.

27. The system of claim 23, wherein the information source is a televised popularity ranking.

28. The system of claim 23, wherein the information source is a published popularity ranking.

29. The system of claim 23, wherein the information source is a popularity ranking broadcasted on a radio program.

30. The system of claim 23, wherein the information source is a popularity ranking posted on the Internet.

31. The system of claim 23, wherein the system operates on a computer.

32. The system of claim 23, wherein the media distribution network operates through a wide area network.

33. The system of claim 23, wherein the media distribution network operates through the Internet.

34. The system of claim 23, wherein the media vending machine is located at the point of sale location.

35. The system of claim 23, wherein the media purveyor receives inventory data from a warehouse.

36. The system of claim 23, wherein the media purveyor distributes the media storage units to the point of sale location.

37. The system of claim 23, wherein the media purveyor receives demographic data from a third party.

38. The system of claim 23, wherein the media purveyor sends the media storage units to a vendor for placement in the media vending machine.

39. The system of claim 23, wherein the media purveyor receives unused media storage units from the vendor and sends the unused media storage units to the media producer.

40. The system of claim 23, wherein the popularity data is projected popularity data.

41. The system of claim 23, wherein the media storage unit is a compact disc, a DVD, a video game, a VHS tape, a flash memory, or computer software.

42. A media vending machine comprising:
a housing having therein locations for receiving a plurality of media storage units;
a plurality of actuators operably connected to the housing such that a user can operate one of the plurality of actuators in order to make a selection from one of the plurality of media storage units;
a plurality of actuator images operably associated with respective ones of the plurality of actuators, the plurality of actuator images corresponding to displays operably connected to corresponding media storage units, the plurality of actuator images being arranged according to popularity of the media storage unit wherein popularity is determined by demographic data in the geographic location in which the media vending machine is positioned;
a payment receiver operably connected to the housing;
a vending tray that receives at least one of the plurality of media storage units after the user has provided payment to the payment receiver and has made a selection from one of the plurality of actuators; and
a controller operably connected to the plurality of actuators, the controller, upon the user's selection of one of the plurality of actuators selecting the media storage unit corresponding to the selected actuator and dispensing the corresponding media storage unit in the vending tray.

43. The media vending machine of claim 42, wherein the payment receiver accepts an electronic payment.

44. The media vending machine of claim 42, further comprising a change tray operably connected to the housing of the media vending machine.

45. The media vending machine of claim 42, wherein the media storage unit is a compact disc, a DVD, a video game, a VHS tape, a flash memory, or computer software.

46. The media vending machine of claim 42, wherein the plurality of actuator images is a plurality of paper displays or a plurality of video images corresponding to the covers of the media storage units.

47. The media vending machine of claim 42, wherein the actuator image is displayed on a liquid crystal or plasma display.

48. The media vending machine of claim 42, wherein the top ten most popular media storage units for a given geographic location correspond to ten actuators.

49. The media vending machine of claim 42, wherein the demographic data is obtained through a statistical analysis service.

50. The media vending machine of claim 42, further comprising a consumer selection tracker which determines popularity of media storage units by recording selection habits of consumers.

51. The media vending machine of claim 42, further comprising an advertising faceplate operably connected to the housing of the media vending machine.

52. The media vending machine of claim 51, wherein an image corresponding to the display operably connected to the media storage unit is placed on the advertising faceplate.

53. The media vending machine of claim 42, wherein the image is displayed on a liquid crystal or plasma display.

54. The media vending machine of claim 42, wherein the positioning of the plurality of actuators is determined by the payment an advertiser submits for advertising a media storage unit.

55. The media vending machine of claim 42, further comprising a coupon dispenser that upon selection and payment of the media storage unit dispenses a coupon for purchase of a product in a retail store.

56. The media vending machine of claim 42, wherein the payment receiver accepts a promotion generated coupon as at least partial payment for the media storage unit.

57. The media vending machine of claim 42, wherein the payment receiver accepts a prize redemption ticket as at least partial payment for the media storage unit.

58. The media vending machine of claim 42, wherein the payment receiver cooperates with a payment software module residing in a handheld electronic device.

59. A method for displaying advertisements on a media vending machine, the method comprising:
providing advertisers with data to assist the advertisers in making an offer for advertising space on the media vending machine;
receiving a first plurality of proposed offers from advertisers for advertising space on the media vending machine;
selecting a first offer from the first plurality of proposed offers for advertising space on the media vending machine;
attaching a first advertisement corresponding to the selected first offer to the media vending machine;
receiving a second plurality of offers from advertisers for advertising space on the media vending machine after a period of time has elapsed;
selecting a second offer from the second plurality of proposed offers for advertising space on the media vending machine;
removing the first advertisement from the media vending machine; and
attaching a second advertisement corresponding to the selected second offer to the media vending machine.

60. The method of claim 59, wherein the first advertisement is attached to a side panel of the media vending machine.

61. The method of claim 59, wherein the second advertisement is attached to a side panel of the media vending machine.

62. The method of claim 59, further comprising after the removing of the first advertisement, providing the advertisers with additional data to assist the advertisers in making another offer for advertising space on the media vending machine.

63. The method of claim 59, wherein the data is demographic data.

64. The method of claim 59, further comprising opening a door operably connected to the side panel.

65. The method of claim 59, wherein the attaching includes clipping the first advertisement to the inside of the door operably connected to the side panel.

66. The method of claim 59, wherein the attaching includes gluing the first advertisement to the inside of the door of the side panel.

67. The method of claim 59, wherein a frame is operably connected to the side panel.

68. The method of claim 67, wherein the attaching of the first advertisement includes sliding the first advertisement through the frame.

69. The method of claim 59, wherein the lapsing of the period of time corresponds to the release date of a publication outlining the popularity of media storage units.

70. The method of claim 59, wherein the lapsing of the period of time corresponds to the promotion of a publication outlining the popularity of media storage units.

71. The method of claim 59, wherein the first advertisement corresponds to a media storage unit housed within the media vending machine.

72. The method of claim 59, wherein the second advertisement corresponds to a media storage unit housed within the media vending machine.

73. The method of claim 59, further comprising attaching a third advertisement operably connected to the media vending machine.

74. The method of claim 73, wherein the third advertisement is for products not housed within the media vending machine.

75. The method of claim 73, wherein the third advertisement is for services.

76. The method of claim 73, wherein the third advertisement corresponds to a media storage unit housed within the media vending machine.

77. A method of positioning media storage units within a media vending machine, the method comprising:
receiving media storage units for positioning within a media vending machine;
positioning the media storage units within the media vending machine;
arranging a plurality of actuator images according to popularity of the media storage unit wherein popularity is determined by demographic data in the geographic location in which the media vending machine is positioned, the plurality of actuators operably connected to the housing such that a user can operate one of the plurality of actuators in order to make a selection from one of the plurality of media storage units; and
sending unused media storage units to a media purveyor.

78. The method of claim 77, wherein the popularity is based on a third party's published ranking of media storage units.

79. The method of claim 78, wherein the popularity comprises projected popularity data.

80. The method of claim 77, wherein the geographic location is a city.

81. The method of claim 77, wherein the defined geographic location is a retail store.

82. The method of claim 77, further comprising positioning the media storage units within the housing of the media vending machine to correspond to the arranging of the plurality of actuator images.

83. The method of claim 77, further comprising positioning the media storage units within the housing of the media vending machine according to popularity of the media storage units.

84. A media vending machine comprising:
a housing having therein locations for receiving a plurality of media storage units;
an actuator system connected to the housing so that a user can operate the actuator system in order to make a selection from one of the plurality of media storage units;
an actuator image operably connected to each of the plurality of actuators corresponding to a display operably connected to a corresponding media storage unit;
a payment receiver operably connected to the housing;
a vending tray that receives at least one of the plurality of media storage units after the user has provided payment to the payment receiver and has made a selection from one of the plurality of actuators; and
a controller operably connected to the plurality of actuators, the controller, upon the user's selection of one of the plurality of actuators selecting the media storage unit corresponding to the selected actuator and dispensing the corresponding media storage unit in the vending tray.

85. The media vending machine of claim 84, wherein the actuator system further comprises a port for receiving an electronic signal from an electronic handheld device indicating the selection from one of the plurality of media storage units.

86. The media vending machine of claim 84, further comprising a port for sending an electronic signal to a handheld electronic device, the electronic signal causing advertisements to be displayed on the handheld electronic device that relate to preferences stored on the handheld electronic device.

87. The media vending machine of claim 84, wherein the actuator system is a dial which a user can turn to make a selection of a media storage unit.

88. The media vending machine of claim 84, wherein the payment receiver accepts an electronic payment.

89. The media vending machine of claim 84, further comprising a change tray operably connected to the housing of the media vending machine.

90. The media vending machine of claim 84, wherein the media storage unit is a compact disc, a DVD, a video game, a VHS tape, a flash memory, or computer software.
